(19) United States
(12) Patent Application Publication
(10) Pub. No.: US 2010/0066852 A1
(43) Pub. Date: Mar. 18, 2010

(54) IMAGE PROCESSING METHOD, INTEGRATED OPTICAL PROCESSOR, AND IMAGE CAPTURE DEVICE USING THE SAME

(76) Inventor: JungTai J. LIN, Taichung City (TW)

Correspondence Address: Muncy, Geissler, Olds & Lowe, PLLC, P.O. BOX 1364, FAIRFAX, VA, 22038-1364, US

(21) Appl. No.: 12/548,823

(22) Filed: Aug. 27, 2009

(30) Foreign Application Priority Data
Sep. 12, 2008 (TW) 097135218

(51) Int. Cl. H04N 5/228; H04N 5/225

(52) U.S. Cl. 348/222.1; 348/340; 348/E05.031; 348/E05.024

(57) ABSTRACT

The present invention provides an image capture device including an integrated optical processor which includes a substrate, an image sensing circuit, an analogue-to-digital conversion circuit, a digital image signal processing circuit, and a signal output circuit. The signal output circuit has a high-speed serial transmission interface. The light beam received by the image sensing circuit will be converted into digital signals which are further processed by the digital image signal processing circuit. The digital image signal processing circuit also compensates for the signal variation caused by heat generated by high-speed serial transmission interface.

### BACKGROUND OF THE INVENTION

1. Field of the Invention

This invention relates to an integrated optical processor, an image signal processing method thereof and an image capture device using the integrated optical processor. More specifically, the present invention relates to an integrated optical processor having an image capture function and an image processing method thereof.

2. Description of the Prior Art

In recent years, digital image capture devices are now extensively applied as the digital image processing technology progresses. For instance, digital cameras, web cameras or electronic devices capable of taking pictures such as mobile phones, are very popular consumer electronic products. Thus, the designs for digital image capture system are to be further improved for acquiring images of higher resolution and for achieving high-speed data access.

FIG. 1A is a block diagram illustrating a conventional processor used in image capture systems. An image sensing module 12 and a digital image processing module 14 are integrated into a processor 10. The image sensing module 12 detects light beams and then obtains corresponding image signals. The digital image processing module 14 receives image signals from the image sensing module 12 and then performs further image processing techniques, such as sampling, exposure compensation, and white balance, in order to obtain a correct image output. As shown in FIG. 1A, the high-speed signal output module 16 and the processor 10 are two separate modules, wherein the processor 10 inputs the processed image signals into the high-speed signal output module 16. The image signals will then be transmitted to other devices, after they are processed by the high-speed signal output module 16.

FIG. 1B is a block diagram illustrating another conventional processor 10′ used in image capture devices. As shown in FIG. 1B, a digital image processing module 14′ and a high-speed signal transmission module 16′ are integrated into the processor 10, while the image sensing module 12′ is separated from the processor 10′. The image sensing module 12′ obtains image signals and then transmits the image signals obtained to the digital image processing module 14′ for further image processing. Afterwards, the image signals are transmitted to other devices by the high-speed signal transmission module 16′.

However, the two image capture systems and the processors thereof described above require image signals to be transmitted between modules, which limit the transmission speed of signals. Furthermore, high definition images also represent higher amount of data to be processed and transmitted which may create certain problem to be resolved. For instance, high-speed data transmission may create heat which causes deterioration or even damages in the images.

### SUMMARY OF THE INVENTION

It is an object of the present invention to provide an integrated optical processor for integrating the functions of image sensing, image processing and high-speed data transmission.

It is another object of the present invention to provide an integrated optical processor to solve problems caused by heat generated during high-speed data transmission.

It is yet another object of the present invention to provide an image capture device including the integrated optical processor for improved image processing and data transmission.

It is one of the objects of the present invention to provide an image processing method, which integrates the functions of image sensing, image processing, and high-speed data transmission and provides an effective image compensation method.

The image capture device of the present invention includes an integrated optical processor, a lens unit, and a signal output port. The integrated optical processor includes a substrate, an image sensing circuit, an analogue-to-digital conversion circuit, a digital image signal processing circuit and a signal output circuit. The image sensing circuit is disposed on the substrate and generates an analogue original image signal corresponding to light signals received by the lens unit. The analogue-to-digital conversion circuit converts the analogue original image signal into a digital original image signal. The digital image signal processing circuit is electrically connected to the analogue-to-digital conversion circuit to process the digital original image signal according to a predetermined manner and then generates a digital output image signal corresponding to the digital original image signal. The signal output circuit has a high-speed serial transmission interface capable of transmitting the digital output image signal to the signal output port at a transmission rate equal to or greater than 480 Mbits/s. The digital image signal processing circuit compensates for signal variations in the digital original image signal according to predetermined manner. The above-mentioned signal variations are caused by heat generated by the high-speed serial transmission interface.

The image processing method of the present invention includes a step of generating an analogue original image signal based on a light signal, a step of converting the analogue original image signal into a digital original image signal, a step of processing the digital original image signal in accordance with a predetermined manner to generate a corresponding output image signal, a step of transmitting the digital output image signal at a data transmission rate equal to or greater than 480 Mbits/s, and a step of compensating for a signal variation according to the predetermined manner, wherein the signal variation is caused by a heat generated by a high-speed serial transmission interface.

### BRIEF DESCRIPTION OF THE DRAWINGS

FIG. 1A is a block diagram illustrating a processor in a conventional image capture system;

FIG. 1B is a block diagram illustrating another processor in a conventional image capture systems;

FIG. 2 is a block diagram illustrating an image capture device and an integrated optical processor thereof in accordance with one embodiment of the present invention;

FIG. 3 is a block diagram of an image sensing circuit of FIG. 2;

FIG. 4A, FIG. 4C, FIG. 4D, FIG. 4E, and FIG. 4F are block diagrams of the digital image signal processing circuit in different embodiments of the present invention;

FIG. 4B is a waveform diagram illustrating an image signal before and after being processed by a filter unit; and

FIG. 5, FIG. 6A, FIG. 6B, FIG. 6C and FIG. 6D are flow charts illustrating the image signal processing method in various embodiments of the present invention.

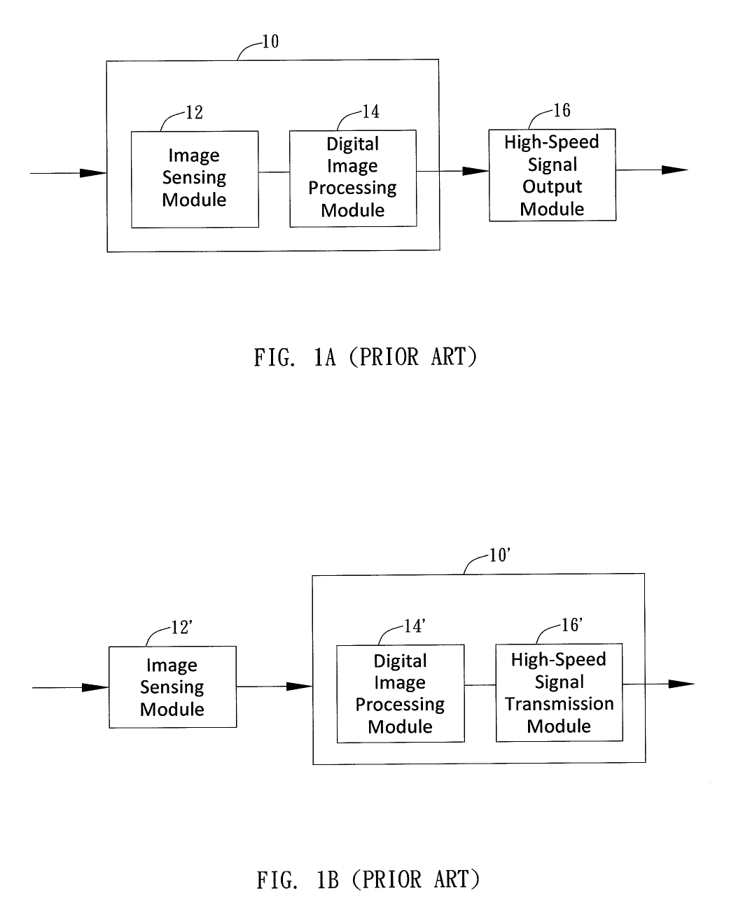

### DETAILED DESCRIPTION OF THE PREFERRED EMBODIMENT

The present invention relates to an integrated optical processor, an image signal processing method thereof, and an image capture device. The integrated optical processor of the present invention includes a digital integrated circuit chip (IC chip). The image capture device includes digital cameras, web cameras, or other electronic devices having image capture function.

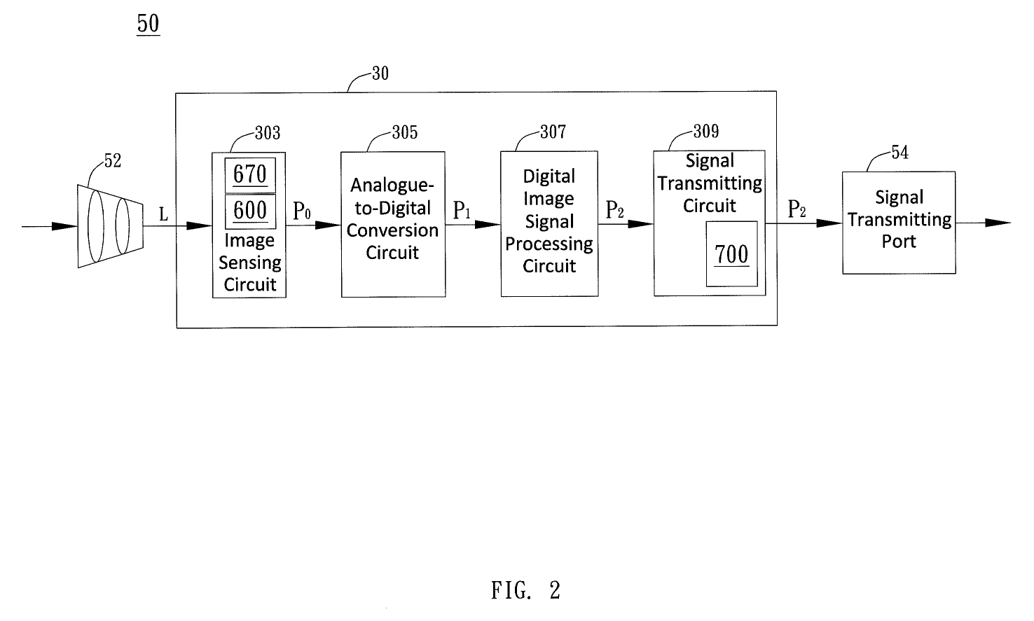

FIG. 2 is a block diagram illustrating an image capture device 50 and an integrated optical processor 30 thereof in accordance with one embodiment of the present invention. The image capture device 50 includes the integrated optical processor 30, a lens unit 52, and a signal transmission port 54. The lens unit 52 includes one or more optical lenses for directing external light beams to the image capture device 50. The integrated optical processor 30 includes a substrate (not illustrated), an image sensing circuit 303, an analogue-to-digital conversion circuit 305, a digital image signal processing circuit 307 and a signal output circuit 309. The substrate is used as a carrier board in various types of chip packaging technologies to carry digital integrated circuits. The circuit packaging technologies includes pin grid array package, ball grid array package, or in-line package or other types of packing technologies. The image sensing circuit 303 includes a pixel array 600 disposed on the substrate for receiving a light signal L and generating a corresponding analogue original image signal P₀. The analogue-to-digital conversion circuit 305 is disposed on the substrate and is also connected to the output terminal of the image sensing circuit 303 for converting the analogue original image signal P₀ into a digital original image signal P₁. The digital image signal processing circuit 307 is connected to the analogue-to-digital circuit 305. The digital image signal processing circuit 307 processes the digital original image signal P₁ according to a predetermined manner and then generates a digital output image signal P₂. The above-mentioned image processing includes exposure adjustments, white balance, and color correction of images, but is not limited thereto. The signal output circuit 309 is connected to the output terminal of the digital image signal processing circuit 307. The signal output circuit 309 further includes a high-speed serial transmission interface 700 for transmitting digital output image signal P₂ to the signal transmission port 54 of the image capture device 50. The high-speed serial transmission interface 700 has a data transmission rate equal to or greater than 480 Mbit/s and includes transmission interfaces such as universal serial bus 2.0, super high-speed universal serial bus 3.0, etc.

In another embodiment of the image sensing circuit 303 illustrated in FIG. 2, the image sensing circuit 303 may optionally include a photosensing layer 670 used to sense a specific color in lights and generating a light signal corresponding to the chromaticity or the brightness of the specific light.

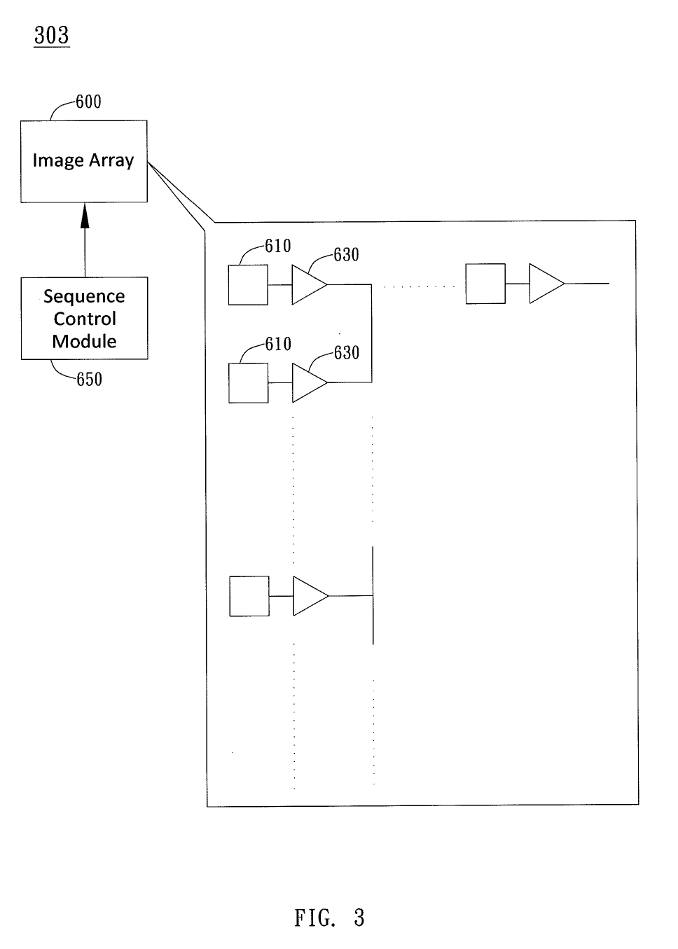

FIG. 3 is a block diagram illustrating the image sensing circuit 303 in accordance with one embodiment of the present invention. The image sensing circuit 303 has an image array 600 which includes a plurality of light-sensing diodes 610 for receiving light signals and generating a voltage according to the magnitude of light signals. The light-sensing diodes 610 preferably include complementary metal-oxide-semiconductor (CMOS). However, in different embodiments, the light-sensing diodes 610 can include other types of light-sensing components. As shown in FIG. 3, the output terminal of each light-sensing diode is connected to an amplifier 630. The amplifier 630 amplifies the voltage from the corresponding light-sensing diode 610 to generate the analogue original image signal P₀. The image sensing circuit 303 also has a sequence control unit 650 connected to the image array 600. The sequence control unit 650 controls the output sequence of sensed images sensed by the light-sensing diodes 610 and the amplifiers 630 in the image array 600. In another embodiment, when the photosensing layer 670 is provided, the light-sensing diode 610 can detect the light signal from the photosensing layer 670 to generate a voltage accordingly.

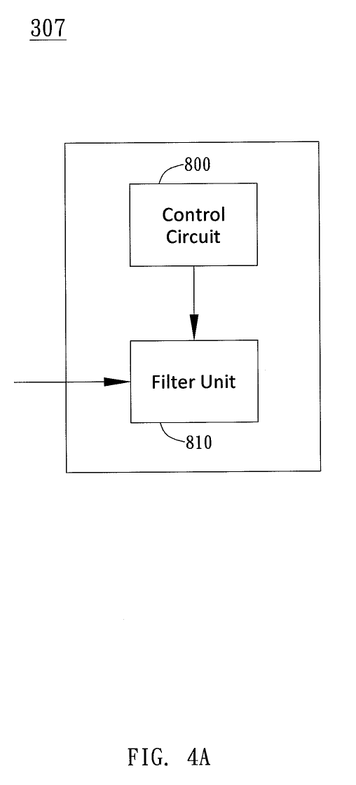

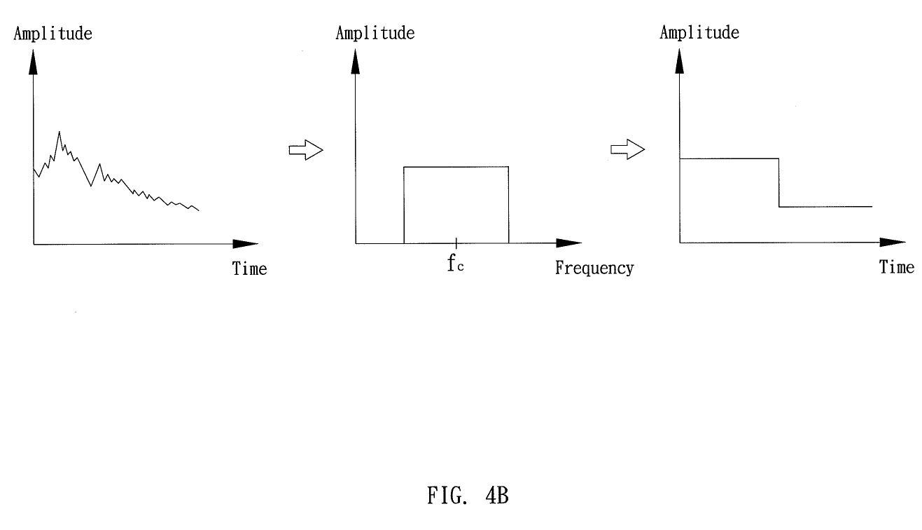

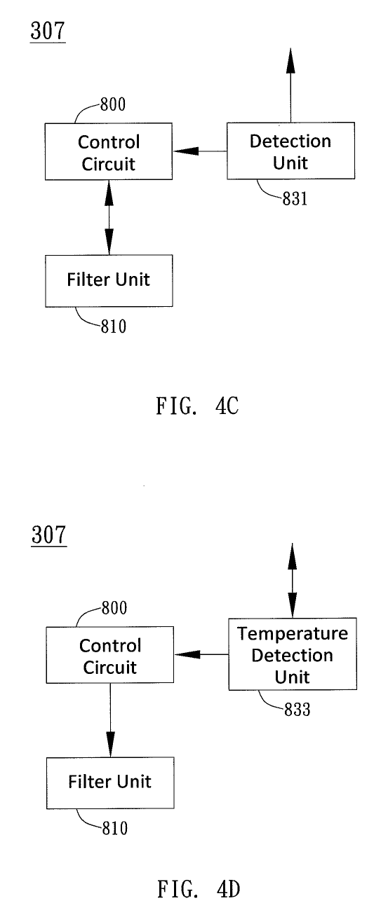

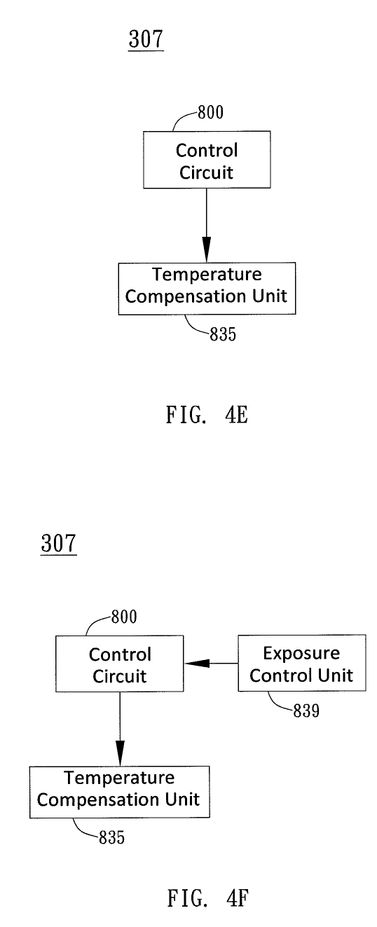

The digital image signal processing circuit 307 of the present invention processes the digital original image signal P₁ according to a predetermined manner to generate a corresponding digital output image signal P₂. Furthermore, the high-speed serial transmission interface 700 generates heat during signal transmission and the heat may affect the magnitude and waveform (phase) of both the digital original image signal P₁ and the digital output image signal P₂, and distorts the image. Thus, the image signal processing circuit 307 is used to compensate for signal variations ΔP in the digital original image signal P₁ caused by heat generated by the high-speed serial transmission interface 700. FIG. 4A is a block diagram illustrating the digital image signal processing circuit 307 in the embodiment described above. As shown in FIG. 4A, the digital image signal processing circuit 307 has a control circuit 800 and a filter unit 810. The control circuit 800 generates a control signal for the signal variation ΔP to be filtered out by the filter unit 810. For instance, if a high-frequency noise caused by heat is defined as signal variation ΔP, then the filter unit 810 can be designed as a low-pass filter or a band-pass filter for filtering out high frequency noises associated with the signal variation ΔP. FIG. 4B illustrates waveform diagrams of the digital original image signal P₁ before and after passing through the filter unit 810. The noise caused by heat generated by the high-speed serial transmission interface 700 can be detected during system design, and thus the filter unit 810 can be designed to filter out the noises detected. The waveform having irregular high frequency oscillations on the left-hand side of FIG. 4B is the digital original image signal P₁ mixed with the signal variation ΔP. The waveform at the middle of FIG. 4B illustrates the frequency response of the filter unit 810, wherein the above-mentioned filter unit 810 is a band-pass filter having frequency response centred at fc. The smooth waveform on the right-hand side of FIG. 4b illustrates the digital original image signal P₁ passing through the filter unit 810 which filters out the noises previously mixed with the digital original image signal P₁.

FIG. 4C is a block diagram of the digital image signal processing circuit 307 in another embodiment of the present invention. As shown in FIG. 4C, the digital image signal processing circuit 307 includes a control circuit 800, a filter unit 810 and a detection unit 831. The detection unit 831 is used to detect whether the magnitude of the noises (signal variation ΔP) is greater than a specified value. If the magnitude of the noise is greater than the specified value, then the detection unit 831 will send an interruption signal to the control circuit 800 to signify that the magnitude of the noise is greater than the specified value and that the digital original image signal P₁ is distorted by the signal variation ΔP. Afterward, the control circuit 800 will send an activation signal to enable the filter unit 810 to filter out the noises in the digital original image signal P₁.

FIG. 4D is a block diagram of the digital image signal processing circuit 307 in yet another embodiment of the present invention. As shown in FIG. 4D, the digital image signal processing circuit 307 includes a control circuit 800, a filter unit 810, and a temperature detection unit 833. The temperature detection unit 833 detects, of example, the image sensing circuit 303 or the analogue-to-digital conversion circuit 305. In the present embodiment, the heat generated by the high-speed serial transmission interface 700 will reflect on the temperature detected by the temperature detection unit 833. The higher the temperature is detected, the more the heat is generated by the high-speed serial transmission interface 700, and thus the digital original image signal P₁ may be further distorted. If the temperature is higher than the predetermined value, then the temperature detection unit 833 will send an interruption signal to the control circuit 800 to signify that the temperature detected is higher than a predetermined value. Afterward, the control circuit 800 will send an activation signal to enable the filter unit 810 to filter out the noises in the digital original image signal P₁.

Furthermore, as shown in FIG. 4E, the digital image signal processing circuit 307 of yet another embodiment includes a control circuit 800 and a color temperature compensation unit 835. In the present embodiment, the heat generated by the high-speed serial transmission interface 700 includes the signal variation ΔP which may affect the color temperature expression of digital original image signal P₁. The control circuit 800 activates the color temperature compensation unit 835 to compensate for the signal variation ΔP and to adjust the digital original image signal P₁ to the correct color temperature value. FIG. 4F is a block diagram illustrating the digital image signal processing circuit 307 in still another embodiment of the present invention. The digital image signal processing circuit 307 of the present embodiment includes a control circuit 800, a color compensation unit 837 and an exposure compensation unit 839. The heat generated by the high-speed serial transmission interface 700 creates a signal variation ΔP which influences the color temperature expression of the digital original image signal P₁ and the correctness of exposure to light. Similarly, the control circuit 800 activates the color compensation unit 837 to compensate for the signal variation ΔP, or to compensate for color distortion in images caused by the signal variation ΔP by, for instance, filtering out noises. The control circuit 800 activates the exposure compensation unit 839 to correct the exposure deviation created by the signal variation ΔP. FIG. 4A, FIG. 4B, FIG. 4C, FIG. 4D, FIG. 4E and FIG. 4F illustrates various embodiments of the digital image signal processing circuit 307 of the present invention used to compensate for the signal variation ΔP caused by heat generated by high data transmission of the high-speed serial transmission interface 700. However, the components in the embodiments described above may be arranged in different combinations to compensate for signal variation and thus do not limit the scope of the present invention.

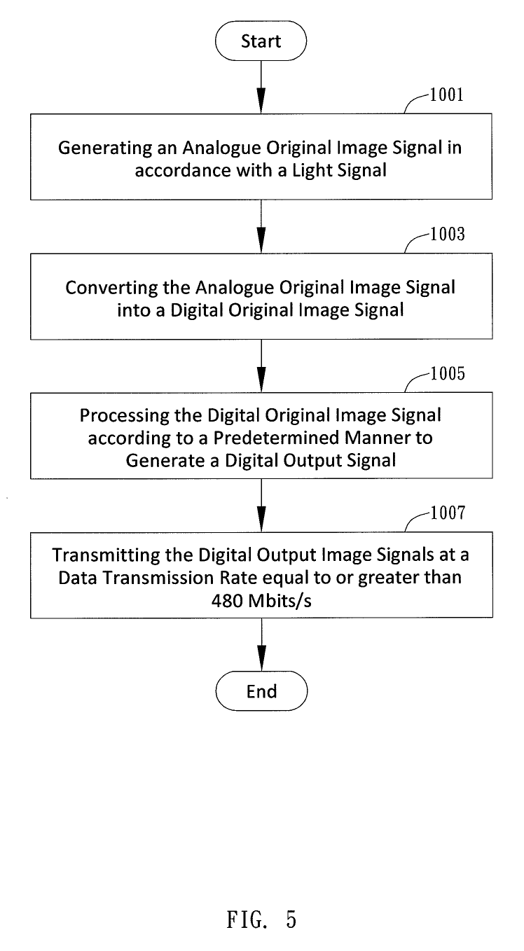

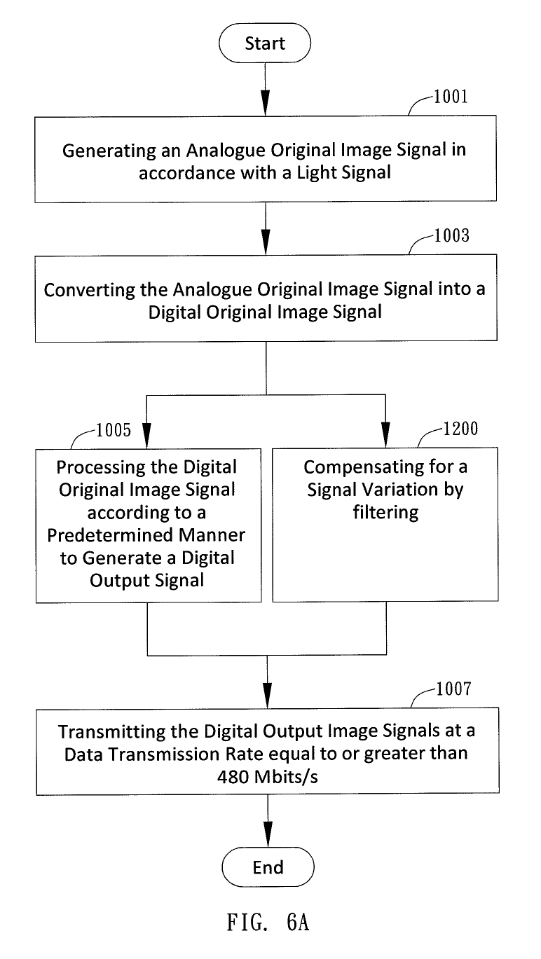

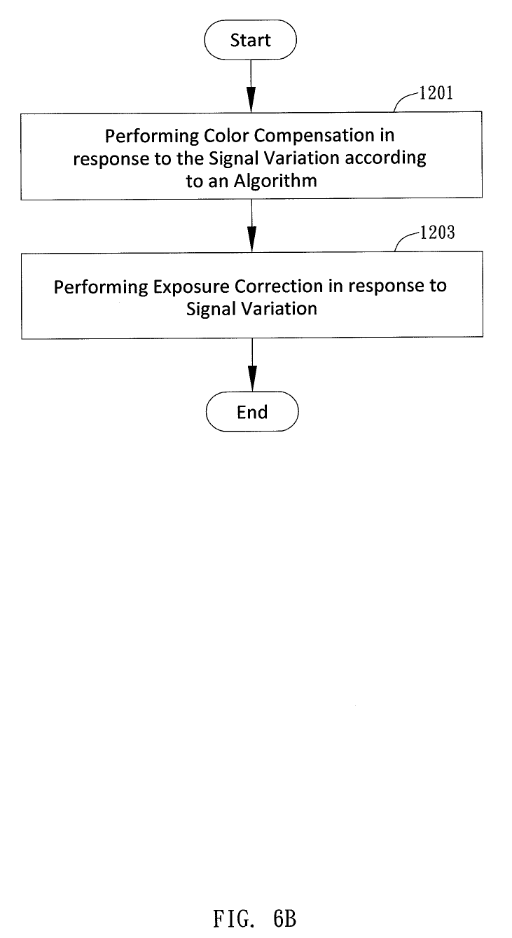

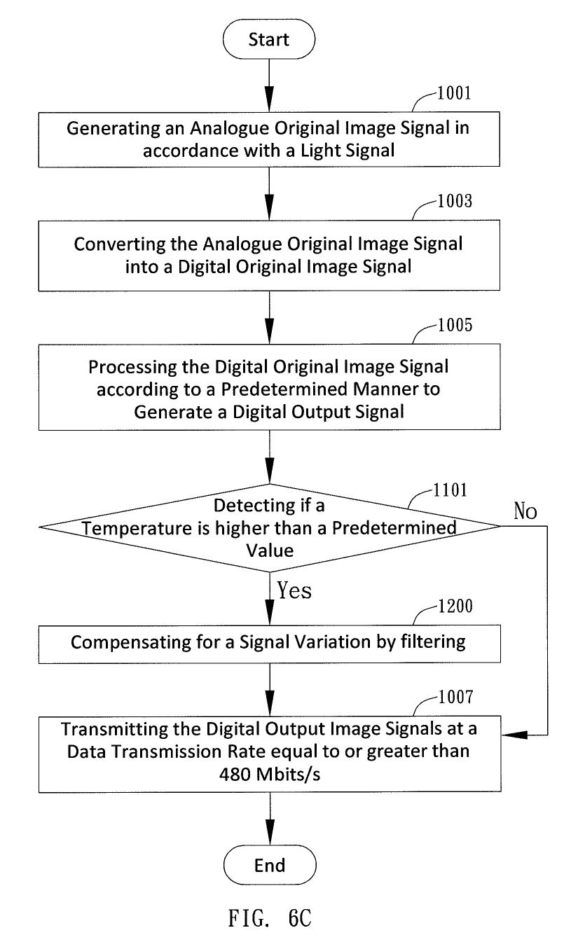

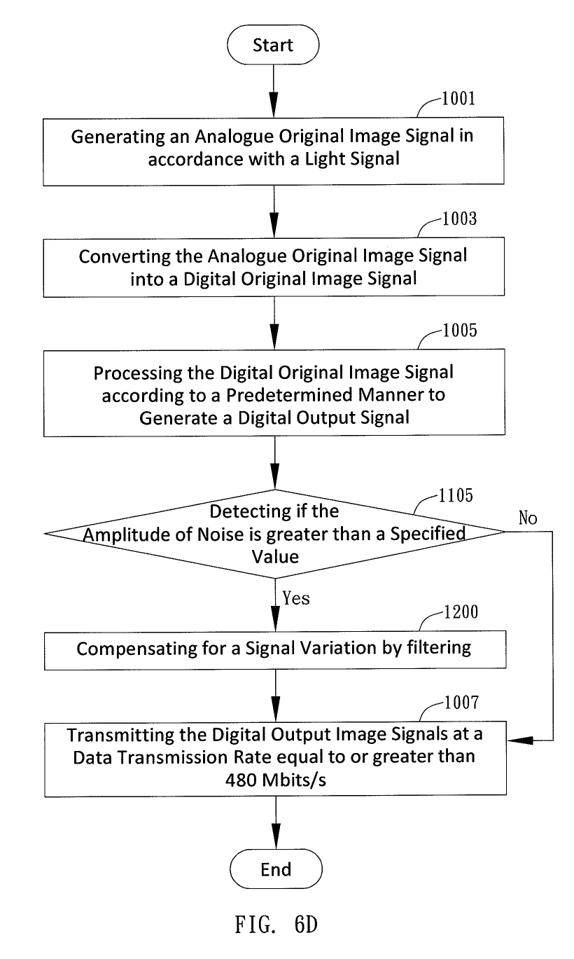

In the flow chart illustrated in FIG. 5, the present invention provides an image signal processing method for processing image signals obtained by an image capture device. Firstly, step 1001 includes generating an analogue original image signal in accordance with a light signal. More specifically, the step 1001 includes generating voltages corresponding to the magnitude of light signals. For instance, the stronger the light is, the higher the voltage is generated. Step 1003 is performed after the generated voltage is amplified and includes converting the analogue original image signal into a digital original image signal using an analogue-to-digital conversion circuit. Afterward, step 1005 includes processing the digital original image signal in accordance with a predetermined manner to generate a digital output signal. The step 1005 includes image processes such as exposure adjustment, white balance, color correction, etc. Step 1007 includes transmitting the digital output image signals at a data transmission rate equal to or greater than 480 Mbits/s. In step 1007, the data transmission is performed via a high-speed serial transmission interface such as the high-speed universal serial bus 2.0, super high-speed universal serial bus 3.0 or other suitable data transmission interface.

The image signal processing method of the present invention may further include step 1200 of compensating for a signal variation according to a predetermined manner, wherein the signal variation is created by the heat generated during the high-speed data transmission. It should be noted that the step 1200 is not performed after step 1007 and can be performed at any suitable times during the image signal processing. In one embodiment, the image signal processing method of the present invention proceeds from step 1001 to step 1005 and step 1200 is performed simultaneously with step 1005 (as shown in FIG. 6A). In another embodiment, at the beginning of image signal processing and that of the high-speed data transmission, the signal variation caused by heat is not significant and does not require compensation and thus step 1200 will not be performed. The step 1200 will only be performed when the signal variation caused by heat is determined to have significant influence on the digital output image signal and this will be further explained below.

As shown in the flow chart of FIG. 6A, the analogue original image signal is converted into the digital original image signal in step 1003. Afterward, the digital original image signal will be processed in step 1005 and signal variations will be compensated in step 1200. In the embodiment illustrated in FIG. 6A, the signal compensation in step 1200 involves filtering out the signal variations in the digital original image signal. The signal variations of the present embodiment can be high-frequency noises caused by heat. Examples of the signal compensation of step 1200 in other embodiments include color temperature compensation, color compensation, exposure correction, or other image processes. However, in different embodiments, the image processes for signal variation compensation can have other combinations. For instance, in the flow chart illustrated in FIG. 6B, step 1200 can include step 1201 of performing a color compensation in response to the signal variation according to an algorithm. Step 1200 can also include step 1203 of performing exposure correction in response to the signal variation.

FIG. 6C is a flow chart illustrating another embodiment of the image signal processing method of the present invention. The image signal processing method includes step 1001, step 1003, step 1005, and step 1007 identical to those described above. However, the present embodiment further includes step 1101 of detecting if a temperature at the image sensing circuit or the analogue-to-digital conversion circuit is higher than a predetermined value. If the temperature detected is higher than a predetermined value, then step 1200 is performed before step 1007. Step 1200 compensates for the signal variations by filtering signal variation out. Step 1007 of the present embodiment is described in the previous section and includes transmitting the digital output image signal at a data transmission rate equal to or greater than 480 Mbits/s.

FIG. 6D is a flow chart illustrating the image signal processing method in yet another embodiment of the present invention. The image signal processing method includes step 1001, step 1003, step 1005, and step 1007 identical to those described above. It should be noted that the image signal processing method of the present embodiment includes step 1105 of detecting whereas the magnitude of noise (signal variation) is greater than a specified value. If the magnitude of noise detected in step 11 05 is greater than a specified value, then step 1200 is performed to filter out the noise detected, and then step 1007 is performed. Otherwise, if the magnitude of noise is not greater than the specified value, step 1200 can be omitte and step 1007 is performed. In the embodiments illustrated in FIG. 6C and FIG. 6D, at the beginning of the image signal processing method, the signal variation caused during heat generated by high-speed data transmission does not require compensation and thus step 1200 is omitted. However, if the signal variation caused by heat is determined to have significant influence on the digital output image signals, step 1200 will then be performed.

The above is a detailed description of the particular embodiments of the invention which not intended to limit the invention to the embodiments described. It is recognized that modifications within the scope of the invention will occur to a person skilled in the art. Such modifications and equivalents of the invention are intended for inclusion within the scope of this invention.

What is claimed is:

1. An integrated optical processor used in an image capture device, the optical processor comprising:
a substrate;
an image sensing circuit having an image array disposed on the substrate for generating an analogue original image signal according to a light signal;
an analogue-to-digital conversion circuit disposed on the substrate for converting the analogue original image signal into a digital original image signal;
a digital image signal processing circuit for processing the digital original image signal according to a predetermined manner to generate a digital output image signal; and
a signal output circuit, disposed on the substrate, having a high-speed serial transmission interface, the high-speed serial transmission interface outputs the digital output image signal at a data transmission rate equal to or greater than 480 Mbits/s, wherein the predetermined manner of the digital image signal processing circuit compensates for a signal variation in the digital output image signal caused by a heat generated by the high-speed serial transmission interface.

2. The integrated optical processor of claim 1, wherein the digital image signal processing circuit includes a filter unit for filtering out a noise corresponding to the signal variation.

3. The integrated optical processor of claim 2, wherein the digital image signal processing circuit further includes a temperature detection unit for detecting whether a temperature is higher than a predetermined value, the filter unit is activated when the temperature is higher than the predetermined value.

4. The integrated optical processor of claim 2, wherein the digital image signal processing circuit further includes a detection unit for detecting whether the noise is greater than a specified value, the filter unit is activated when the noise is greater than the specified value.

5. The integrated optical processor of claim 1, wherein the digital image signal processing circuit includes a color temperature compensation unit for performing color temperature compensation in response to the signal variation.

6. The integrated optical processor of claim 1, wherein the digital image signal processing circuit further includes:
a color compensation unit for performing color compensation according to an algorithm in response to the signal variation; and
an exposure compensation unit for performing exposure correction in response to the signal variation.

7. The integrated optical processor of claim 1, wherein the image sensing circuit includes a photosensing layer for sensing specific colors in a light and generating the corresponding light signal.

8. The integrated optical processor of claim 1, wherein the image array includes:
a light-sensing diode for generating a voltage according to a magnitude of the light signal; and
an amplifier for amplifying the voltage and then transmitting the voltage to the analogue-to-digital conversion circuit to be processed.

9. An image signal processing method used in an image capture device, the image signal processing method comprising:
generating an analogue original image signal in accordance with a light signal;
converting the analogue original image signal into a digital original image signal;
processing the digital original image signal in accordance with a predetermined manner to generate a digital output image signal;
transmitting the digital output image signal at a data transmission rate equal to or greater than 480 Mbits/s; and
compensating for a signal variation according to the predetermined manner, wherein the signal variation is caused by a heat generated during high-speed serial transmission.

10. The image signal processing method of claim 9, wherein the step of transmitting the digital output image signal further includes outputting the digital output image signal via a high-speed serial transmission interface.

11. The image signal processing method of claim 9, wherein the step of compensating for the signal variation includes filtering out a noise corresponding to the signal variation.

12. The image signal processing method of claim 11, wherein the step of compensating for the signal variation further includes:
detecting whether a temperature is higher than a predetermined value; and
filtering out the noise when the temperature is higher than the predetermined value.

13. The image signal processing method of claim 11, wherein the step of compensating for the signal variation further includes:
detecting whether the noise corresponding to the signal variation is greater than a specified value; and
filtering out the noise when the noise is higher than the specified value.

14. The image signal processing method of claim 9, wherein the step of compensating for the signal variation further includes performing a color temperature compensation in response to the signal variation.

15. The image signal processing method of claim 9, wherein the step of compensating for the signal variation compensation step further includes:
performing a color compensation in response to the signal variation according to an algorithm; and
performing an exposure correction in response to the signal variation.

16. The image signal processing method of claim 9, wherein the step of generating the analogue original image signal in accordance with the light signal includes:
generating a voltage according to a magnitude of the light signal; and
amplifying the voltage and transmitting the voltage to an analogue-to-digital conversion circuit to be processed.

17. An image capture device, comprising:
a lens unit for receiving a light from outside into the image capture device;
a signal transmission port; and
an integrated optical processor comprising:
a substrate;
an image sensing circuit having an image array disposed on the substrate for generating an analogue original image signal in accordance with a light signal;
an analogue-to-digital conversion circuit disposed on the substrate for converting the analogue original image signal into a digital original image signal;
a digital image signal processing circuit for processing the digital original image signal according to a predetermined manner to generate a digital output image signal in accordance with the digital original image signal; and
a signal output circuit, disposed on the substrate, having a high-speed serial transmission interface, the high-speed serial transmission interface outputs the digital output image signal at a data transmission rate equal to or greater than 480 Mbits/s, wherein the predetermined manner of the digital image signal processing circuit compensates for a signal variation in the digital output image signal caused by a heat generated by the high-speed serial transmission interface.

18. The image capture device of claim 17, wherein the image sensing circuit includes a photosensing layer for sensing specific colors in light and generating the corresponding light signal.

19. The image capture device of claim 17, wherein the digital image signal processing circuit includes a filter unit for filtering out a noise corresponding to the signal variation.

20. The image capture device of claim 19, wherein the digital image signal processing circuit further includes a temperature detection unit for detecting whether a temperature is higher than a predetermined value, the filter unit is activated when the temperature is higher than the predetermined value.

21. The image capture device of claim 19, wherein the digital image signal processing circuit further includes a detection unit for detecting whether the noise is greater than a specified value, the filter unit is activated when the noise is greater than the specified value.

22. The image capture device of claim 17, wherein the digital image signal processing circuit includes a color temperature compensation unit for performing a color temperature compensation in response to the signal variation.

23. The image capture device of claim 17, wherein the digital image signal processing circuit further comprises:
a color compensation unit for performing a color compensation according to an algorithm in response to the signal variation; and
an exposure compensation unit for performing an exposure correction in response to the signal variation.
